(19) United States
(12) Patent Application Publication
(10) Pub. No.: US 2026/0105861 A1
(43) Pub. Date: Apr. 16, 2026

(54) Educational Card Game - CPH

(71) Applicant: Clinton Heath, Belleville, NJ (US)

(72) Inventor: Clinton Heath, Belleville, NJ (US)

(21) Appl. No.: 18/800,125

(22) Filed: Oct. 10, 2024

(51) Int. Cl. G09B 19/22; A63F 1/02; G09B 19/00

(52) U.S. Cl. CPC G09B 19/22; A63F 1/02; G09B 19/0046

(57) ABSTRACT

Provided herein is a novel method of game play and game components that in one embodiment consist in the form of playing cards. In one version, the game components comprise a primary deck of educational cards, a random educational category selector, a secondary deck of cards which manipulate the primary cards in play, a tertiary deck of cards to manipulate the primary and/or secondary cards in play, a quaternary deck of cards which might manipulate the primary, secondary and/or tertiary cards in play or manipulate the fundamental rules of play. The goal of the game is to either collect or rid yourself of the most or all the primary and/or secondary cards, or to either have the highest or lowest point total, or to either collect the most or rid yourself of the most or all the assigned tokens.

### TECHNICAL FIELD

The present invention pertains generally to games that combine chance and strategy, and more particularly, a card game that uses playing cards, some containing educational/informational data, and to a method of playing the game, as well as alternative embodiments of the same, including different game formats such as electronic games, interactive networks, computer software, board games, and role-playing games.

### BACKGROUND OF THE INVENTION

Cards have long been a popular method of disbursing & collecting information about public figures. A familiar use is the baseball card that has a photographic depiction of an athlete along with biographical & statistical information about the athlete. Baseball cards and others like them dealing with various sports figures are used by sports enthusiasts to educate themselves about players, teams and sports history in general. Such cards have also been developed in other areas, such as the entertainment industry, which have depicted music, television and movie personalities.

There are also cards that depict fictional characters with their own fictitious biographical & statistical information. The thing that differentiates these cards from the cards that depict actual persons is that the fictitious character cards are often used as game pieces in a well-structured and entertaining game.

However, there has not as of yet been a game that effectively uses cards depicting educational/informational figures such as the former Presidents of the United States that integrates their educational/informational achievements as factors in a game of chance & strategy.

### SUMMARY OF THE INVENTION

In one form, the present invention is directed to a game for two or more players, with the possibility that all but one could be virtual. The game components include rules of play and a plurality of game elements which in one form would be represented as physical items such as playing cards and a die and in other forms would be represented accordingly in various electronic versions such as video games, computer games and/or web-based individual and/or multiple-player games.

The main group of game elements will hereafter be referred to as “POTUS Cards”.

Each POTUS Card would have one or more images such as a depiction or depictions on the front and/or back surface of a playing card.

The main section of one face of each POTUS Card would display an image or images of an historical and/or popular figure or figures, or could depict organizations, nations, states, etc. The main section of one face of each POTUS Card would display the name(s) of an historical and/or popular figure(s), organization(s), nation(s), state(s), etc.

The main section of one face of each POTUS Card would also contain a relevant notation or a listing such as a grid which would describe and assign point values to the record of the historical and/or popular figure(s), organization(s), nation(s), state(s), etc. either in a specific category or broken down into multiple categories which would be represented by symbols and/or abbreviations; for example, if the representative images of historical and/or popular figures, organizations, nations, states, etc. are Presidents of the United States, the categories could be identified as “P” for a category based on his/hers presidential record, “N” for a category based on his/her record for holding other national offices such as Vice President, Cabinet Secretary and/or Supreme Court Justice, “S” for a category based on his/her record for holding statewide offices such as United States Senator and/or Governor, “HC” for a category representing generally agreed upon Historical Changes credited to him/her, etc.

One face of each POTUS Card could display their number(s) if their achievements can be catalogued chronologically and/or their standing can be otherwise ranked.

One face of each POTUS Card could display other points of interest that would be considered neutral facts which would have no effect on game play, such as the political party of a President of the United States if the game is based on Presidential achievements. More information (that may have nothing to do with game play) could also be included, such as interesting pieces of trivia about the historical and/or popular figure(s), organization(s), nation(s), state(s), etc.; for example, if the historical and/or popular figures are Presidents of the United States, then interesting pieces of trivia could include facts such as that George W. Bush owned a baseball team or that James Buchanan was a lifelong bachelor.

One of the faces of each POTUS Card could display a fictional alter ego; for example, if the subject is an historical and/or popular figure, the alter ego could be an animal or a superhero.

One of the faces of each POTUS Card would display a caption or captions such as “Champions of The POTUS League” and/or a symbol or symbols such as a silhouette of a superhero.

In accordance with another aspect of the current invention there would be a random selector that will hereafter be referred to as “The Dice”. The Dice would have specialized faces with symbols representing categories in the game; for example, if the historical and/or popular figures are Presidents of the United States with the categories President, National Office, State Office, Landmark, etc., then the faces of The Dice could show a “P” for the President category, “N” for the National Office category, “S” for the State Office category, “HC” for a category for representing generally agreed upon Historical Changes, etc.

In another form of the current invention there would be an additional set of game elements that will hereafter be referred to as “STRATEGY Cards”.

Each STRATEGY Card would have one or more images such as depictions on the front and back surfaces of playing cards.

One face of each STRATEGY Card would describe the effect the card would have on the point values of a category or categories on a POTUS Card or Cards in play or to be played, such as a card which will hereafter be referred to as a “Multiply Card” allowing a player to multiply a POTUS Card's or multiple POTUS Cards' specifically named category or categories points by a specific multiplier, a card which will hereafter be referred to as a “Capture Card” allowing a player to capture a POTUS Card's, or multiple POTUS Cards' specifically named category or categories points from the POTUS Card(s) of an opposing player or players and adding the captured points to one's own POTUS Card's point value (or vice-versa if the point of the game is to have the lowest point total), and a card which will hereafter be referred to as a “Veto Card” allowing a player to nullify any POTUS Card's or Cards' specifically named category or categories points, etc.

One face of each STRATEGY Card would display a symbol representing the STRATEGY Card's “Order of Execution”. For example, if there are three different types of STRATEGY Cards: single category Multiply Cards, single category Capture Cards and single category Veto Cards, and they are all played on the same POTUS Card, the Multiply Card(s) might take effect first and display a “1”, the Capture Card(s) might take effect second and display a “2” and the Veto Card(s) might take effect third and display a “3” regardless of which order they are presented during the round.

One face of each STRATEGY Card could display a symbol such as the number 2 followed by a mathematical multiplication symbol to represent the “Multiply” symbol, a symbol such as a picture of a butterfly net or a bear trap to represent the “Capture” symbol, a symbol such as a large “X” or the typical “No” Symbol (a circle with a diagonal line running through it from upper left to lower right) to represent the “Veto” symbol, etc.

One of the faces of a STRATEGY Card can display a caption or captions such as “Champions of The POTUS League” and/or “STRATEGY Cards”.

In accordance with another aspect of the current invention there an could be an additional set of game elements that would be used as tokens to either reward the winner(s) of the round and/or penalize the loser(s).

In another form of the current invention there would be an additional set of game elements that will hereafter be referred to as “MOUSETRAP Cards”.

Each MOUSETRAP Card would have one or more images such as depictions on the front and back surfaces of playing cards.

One face of each MOUSETRAP Card would describe the effect the card would have on other cards in play or to be played. There could be a type of MOUSETRAP Card that will allow a player to play a SNAFU Card (see below), or a type of MOUSETRAP Card which will hereafter be referred to as a “Swap Card” that allows a player to swap POTUS Cards and/or STRATEGY Cards and/or MOUSETRAP Cards with an opposing player or players, or a type of MOUSETRAP Card which will hereafter to be referred to as a “Reverse Card” that counteracts or reverses the effect(s) of a STRATEGY and/or MOUSETRAP Card or Cards, etc.

One face of each MOUSETRAP Card would display a symbol representing the MOUSETRAP Cards' Order of Execution. For example, if there are 24 MOUSETRAP Cards in the MOUSETRAP Card deck, the cards could be numbered from 1 to 24 representing the order in which each card would take effect if played in the same round; the lowest number taking effect first, the second lowest taking effect second, etc., regardless of which type of MOUSETRAP Card it may be or the order in which it is presented during the round.

One face of each MOUSETRAP Card could display a picture and/or a symbol such as two arrows pointing in opposite directions to represent the “Swap” symbol, a symbol such as a curved arrow resembling a “U” on its side to represent the “Reverse” symbol, a symbol such as a picture of a laughing clown to represent the “SNAFU” symbol, etc.

One of the faces of a MOUSETRAP Card can display a caption or captions such as “Champions of The POTUS League” and/or “MOUSETRAP Cards”.

In another form of the current invention there would be an additional set of game elements that will hereafter be referred to as “SNAFU Cards”.

Each SNAFU Card would have one or more images such as depictions on the front and back surfaces of playing cards.

One face of each SNAFU Card would describe the effect the card would have on all POTUS Cards and/or STRATEGY Cards and/or MOUSETRAP Cards in play or to be played, such as a card which will hereafter be referred to as a “Super Multiply Card” that multiplies all POTUS Cards' named category or categories points, a card which will hereafter be referred to as a “Super Veto Card” wiping out all POTUS Cards' named category or categories points, a card which will hereafter be referred to as a “Super Reverse Card” counteracting or reversing the effect of all STRATEGY and/or MOUSETRAP Cards, a card which will hereafter be referred to as a “Super Swap Card” forcing all players to swap POTUS Cards and/or STRATEGY Cards and/or MOUSETRAP Cards with their opposing players, etc.

One of the faces of each SNAFU Card can display a caption or captions such as “Champions of The POTUS League” and/or “SNAFU Cards” and/or a symbol or symbols such as a question mark or an arrow bent in the shape of a clover leaf.

### BRIEF DESCRIPTION OF THE DRAWINGS

The foregoing and other features and advantages of the present invention will become more readily appreciated as the same become better understood by reference to the following detailed description when taken into conjunction with the accompanying drawings wherein:

FIGS. 1-4A are plan views of the playing face of the playing cards formed in accordance with the present invention with FIGS. 1, 1A & 1B representing a typical POTUS Card, FIGS. 1C, 2 & 2A representing a typical STRATEGY Card, FIGS. 1C, 3 & 3A representing a typical MOUSETRAP Card, and FIGS. 4, 4A & 4B representing a typical SNAFU Card;

FIGS. 5, 5A & 5B are plan views of the playing faces of The Dice, formed in accordance with the present invention;

FIGS. 6. 6A, 6B, 6C, 6D, 6E, 6F & 6G illustrate the layout of the playing surfaces for two to four opponents for the Beginners, Standard, Deluxe and Advanced versions of the present invention.

The reference indicia will be alphanumeric in the following format: [{FIG. (number or number and letter)}{hyphen}{item (number or number and letter)}]; e.g., {1-1}, {3A-12} or {4A-7a}.

### DETAILED DESCRIPTION

The present invention pertains to a game for two or more players wherein the players are assigned a number of cards that they would match against each other to win each round and, eventually, the game. Thus, the present invention is directed to not only the game components, but also the method of playing the game.

It is to be understood that the game components can take different forms. For instance, in one version of the game, the components are hand-holdable cards. In another version of the game, the players could interact with each other via a computer network, with the game components visually displayed on a monitor. Hence, the foregoing game is not to be limited to the embodiments described herein.

Any embodiment of the game can be played on a pre-printed gameboard which could be made of any number of materials (see {6-1} & {6A-1}).

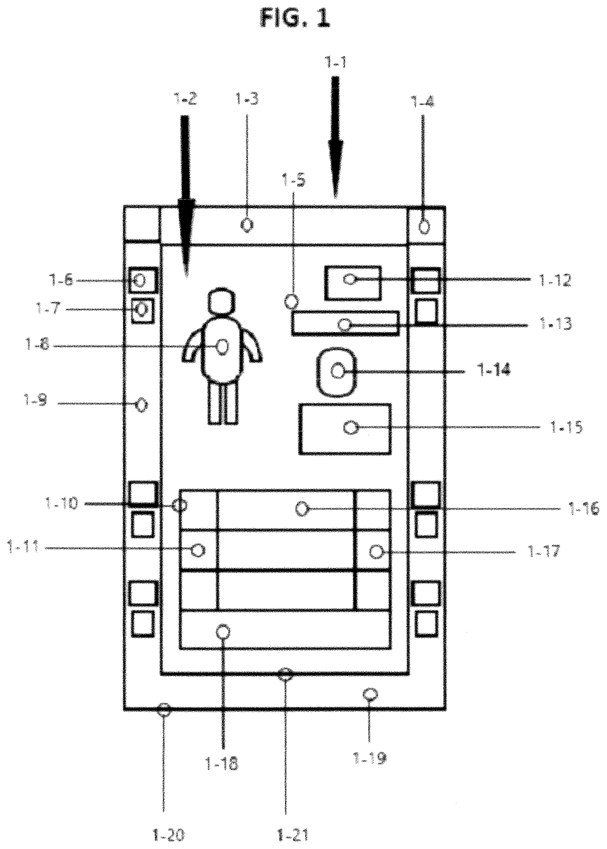

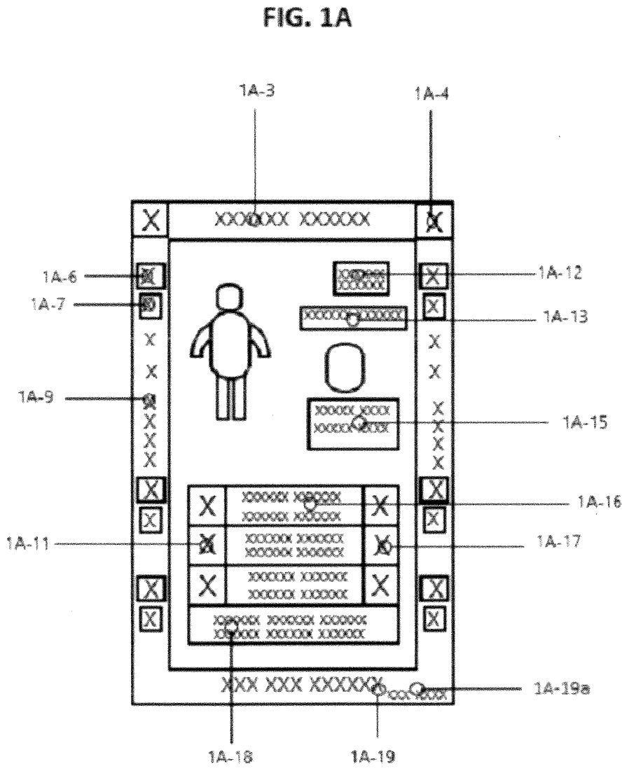

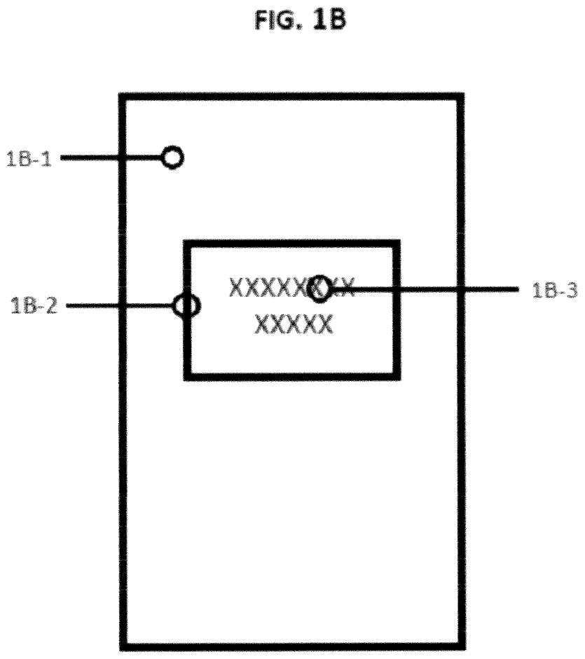

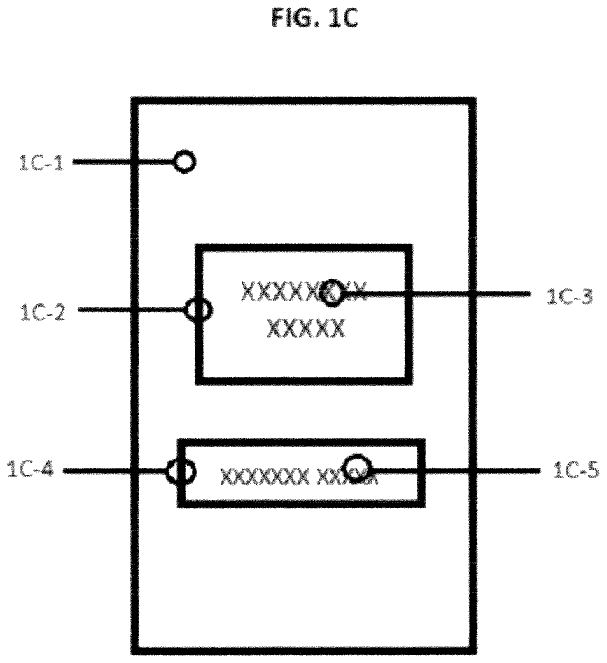

One embodiment of the invention, which could be played on a pre-printed gameboard (see 6 & 6A), will hereafter be referred to as the “Beginners Game”. At the outset of the Beginners Game each player is assigned an equal number of POTUS Cards (see FIGS. 1 and 1A) from the POTUS Card deck either by random selection or by each player taking turns selecting from the deck.

In a typical game, the entire deck of POTUS cards is equally distributed amongst the players, with any residual cards set aside not to be used nor identified. Each player then shuffles their cards, after which the opponents may cut each other's decks. Each player places their POTUS Card deck into their On-Deck section (see {6-6} and {6A-6}) then each player assembles their initial “hand” by taking a predetermined number of cards from the tops of their decks. After the players have arranged their “hands” they take turns operating The Dice (see illustrations 5, 5A and 5B) where that game component is a solid cube (see {5-1}) and all six faces (see {5-2}, {5A-2}, {5B-2}, {5-3}, {5A-3}, {5B-3}, {5-4}, {5A-4}, {5B-4}, {5-5}, {5A-5}, {5B-5}, {5-6}, {5A-6}, {5B-6}, {5-7}, {5A-7} & {5B-7}) would each have a symbol representing a POTUS Card category. Operating The Dice, hereafter to be referred to as “rolling The Dice”, is an action which will reveal which category on the POTUS Cards will enable a player's card to be in primary contention to win that round. After the roll of The Dice each player will then take a card from their “hand” and place it facedown onto the designated playing area (see {6-8} and {6A-8}). Once every player has put a card onto the designated playing area all players turn over those cards and among the cards that match the category identified by The Dice, the card with the highest total points wins (see {1A-4}). In case of a tie, the primary tic-breaker could be the player that has the card with the most points that match the category identified by The Dice. If no one has played a card that matches the category identified by The Dice, the card with the highest total points could win, and the ultimate tie-breaker could be the card that comes first in chronological order (see {1A-19}). In a typical game the winner of the round collects all of the cards played and puts them into their reserve area (see {6-7} and {6A-7}) and then all players take a new card from the top of their On-Deck POTUS Card deck to add to their “hand”. After a player runs out of cards in their On-Deck area they take all of the cards from their reserve area and shuffle them (their opponents can have the option to cut the deck), after which the deck is placed into the On-Deck area and play continues. This continues until only one player has collected all of the cards and wins the game. Alternatively, the game could end when one of the players has run out of cards; then, the goal of the game could be to collect more POTUS Cards than your opponents. In alternate versions of the current embodiment the winner of each round could be the card with the lowest total points, the card with the highest number of points that match the category identified by The Dice, the card with the lowest number of points that match the category identified by The Dice, etc. In another version of the Beginners Game, the big loser of each round would be the one to collect all of the cards played; then, the goal of the game could be to rid yourself of the most or all of your POTUS Cards. The goal of the game in other versions could be to either have the highest running point total, the lowest running point total, to collect the most or all of the assigned tokens, to rid yourself of the most or all of the assigned tokens, etc.

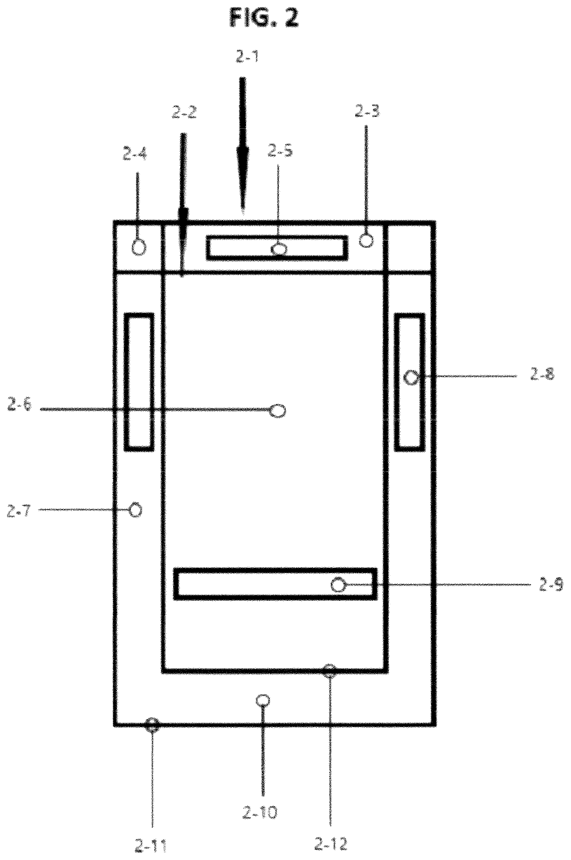

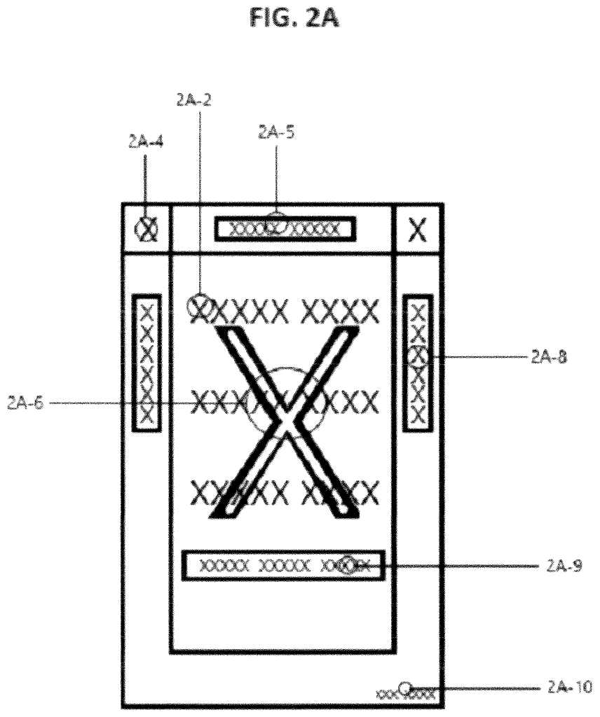

In another embodiment of the invention, which could be played on a pre-printed gameboard (see 6B & 6C), will hereafter be referred to as the “Standard Game”. Besides the POTUS Cards from the Beginners Game, STRATEGY Cards (see FIGS. 2 and 2A) will be introduced which the players can utilize to affect the point totals as well as the eligibility of POTUS Cards in play. In the same manner that each player is assigned POTUS Cards in the Beginners Game, in the Standard Game they are assigned an equal number of POTUS Cards and an identical number of STRATEGY Cards, either by random selection or by each player taking turns selecting from the respective decks, with any residual cards set aside not to be used nor identified. Then, in a typical game, after all cards are assigned each player separately shuffles their POTUS Card deck and their STRATEGY Card deck, after which the opponents may cut each other's decks. Each player places their POTUS Card decks into their POTUS Card On-Deck sections (see {6B-6} & {6C-6}) and STRATEGY Card decks into their STRATEGY Card On-Deck sections (see {6B-6a} and {6C-6a}) after which each player assembles their initial “hand” by taking an identical, predetermined number of cards from the tops of each of their decks. After the players have arranged their “hands” one of the players takes their turn rolling The Dice, which will reveal which POTUS category would put a player in primary contention to win that round. Then each player places a POTUS Card from their “hand” into their designated playing area facedown (see {6B-8} & {6C-8}). After all players have placed a POTUS Card onto the designated playing area they all turn their POTUS Cards on the designated playing area faceup, and then each player activates a STRATEGY Card by pulling the STRATEGY Card from their “hand” while keeping its identity hidden. When every player is ready at least one person counts to three, and on the count of three each player places their activated STRATEGY Card facedown onto the designated section of the designated playing area containing the POTUS Card that their activated STRATEGY Card is intended to affect (see {6B-8a} & {6C-8a}). The option would exist where more than one STRATEGY Card could be played on a single POTUS Card whereby the STRATEGY Cards' Order of Execution would be necessary (see {2A-6} where the “X” represents a number indicating each STRATEGY Card's place in the Order of Execution). Once every player has put a STRATEGY Card onto the designated playing area all players turn their activated STRATEGY Cards faceup. After the effects of the STRATEGY Cards on the point totals of the POTUS Cards have been assessed, of the players who have positive points that match the category identified by The Dice, the player with the highest point total wins the round. In case of a tie, the primary tie-breaker could be the player that has the most points that match the category identified by The Dice. If no one has points that match the category identified by The Dice, the player with the highest total points could win the round. The ultimate tie-breaker could be the POTUS Card that comes first in chronological order. In a typical game the winner of the round collects all of the cards played and puts them into their reserve area (see {6B-7}, {6B-7a}, {6C-7} and {6C-7a}) and then all players take a new card from the top of their On-Deck POTUS Card deck and their On-Deck STRATEGY Card deck to add the cards to their “hand”. After a player runs out of cards in their On-Deck area they take both decks of cards from their reserve area and shuffle them separately, after which their opponents can have the option to cut the decks, then the decks are placed into their respective On-Deck areas and play continues. This continues until only one player has collected all of the cards and wins the game. Alternatively, the game could end when one of the players has run out of cards, then the goal of the game could be to collect more cards than your opponents. In alternate versions of the current embodiment the winner of each round could be the player with the lowest total points, the player with the highest number of points that match the category identified by The Dice, the player with the lowest number of points that match the category identified by The Dice, etc. In another version of the Standard Game, the big loser of each round would be the one to collect all of the cards played; then, the goal of the game could be to rid yourself of the most or all of your cards. The goal of the game in other versions could be to either have the highest running point total, the lowest running point total, to collect the most or all of the assigned tokens, to rid yourself of the most or all of the assigned tokens, etc. In alternate versions of the current embodiment the rolling of The Dice could solely and/or also determine which STRATEGY Cards could be played for that round.

The STRATEGY Cards can be represented by physical objects, such as cards, tokens, blocks, or other game pieces known in the gaming industry, or can be visually displayed electronically or represented by symbols or words, such as on an interactive network or in computer software. The same is true with respect to the POTUS Cards, MOUSETRAP Cards, SNAFU Cards and The Dice. As such, the game components are not to be limited by the embodiments described herein.

This also applies to the method of playing the game. Play can be accomplished between a single player and a virtual player via an artificial intelligence such as a computer, or expanded up to multiple players competing against one or more opposing players, both actual and/or virtual, in a single turn. While the fundamental rules of play apply in multi-player and tournament games, modifications can be made as necessary to accommodate the needs of the game and the desires of the players.

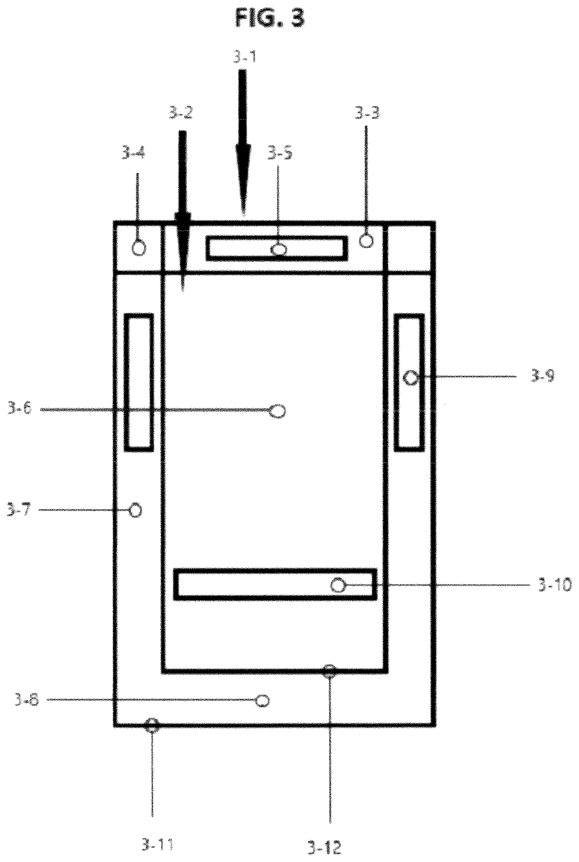

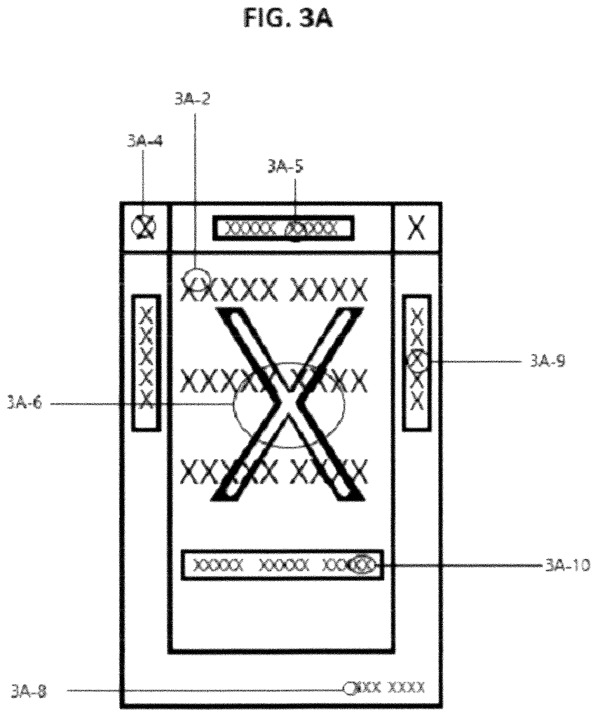

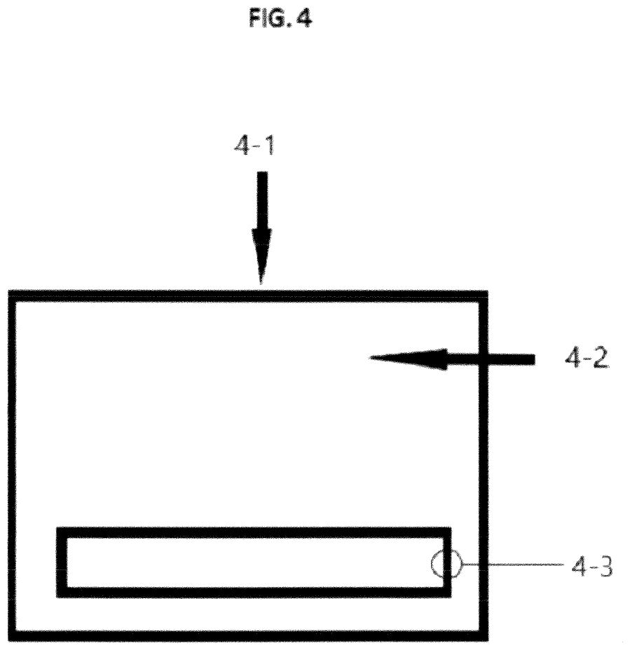

In another embodiment of the invention which could be played on a pre-printed gameboard (see 6D & 6E) and will hereafter be referred to as the “Deluxe Game”, in addition to assigning each player POTUS Cards and STRATEGY Cards as in the Standard Game, each player is also provided with a number of MOUSETRAP Cards (see FIGS. 3 and 3A) which they can utilize to do things such as, for example, affect the ownership of POTUS Cards, STRATEGY Cards and/or MOUSETRAP Cards in play, or to increase, decrease, nullify or reverse the effect(s) of one or more STRATEGY and/or MOUSETRAP Cards in play, etc. The different types of MOUSETRAP Cards can have unique identifiers such as color-coded backgrounds (see {3-6}), for instance red for affecting a single POTUS Card, blue for affecting a single STRATEGY Card, yellow for affecting all POTUS Cards in play, green for affecting all STRATEGY Cards in play, purple for affecting all MOUSETRAP Cards in play and orange for affecting all cards in play. In a typical game, by random selection or by each player taking turns selecting from the respective decks, each player is assigned an equal number of POTUS Cards and an identical number of STRATEGY Cards, as well as an equal number of MOUSETRAP

Cards with any residual cards from the three decks set aside not to be used nor identified. After all cards have been assigned, each player separately shuffles their POTUS Card deck, their STRATEGY Card deck and their MOUSETRAP Card deck after which the opponents may cut each other's decks. Each player places their POTUS Card decks into their On-Deck sections (see {6D-6} & {6E-6}), STRATEGY Card decks into their On-Deck sections (see {6D-6a} and {6E-6a}) and their MOUSETRAP Card decks into their reserve sections (see {6D-7b} and {6E-7b}) after which each player assembles their initial “hand” by taking an identical, predetermined number of cards from the tops of their POTUS Card and STRATEGY Card decks as well as a predetermined number of their MOUSETRAP Cards from that deck. Each round would begin with every player that still possesses at least one MOUSETRAP Card having a MOUSETRAP Card facedown in their designated, On-Deck sections (see {6D-6b} & {6E-6b}). After one of the players takes their turn rolling The Dice, which will reveal which POTUS category would put a player in primary contention to win that round, each player places a POTUS Card from their “hand” into their designated playing area facedown (see {6D-8} & {6E-8}). After all players have placed a POTUS Card onto the designated playing area they all turn their POTUS Cards on the designated playing area faceup, and then each player activates a STRATEGY Card by pulling the STRATEGY Card from their “hand” while keeping its identity hidden. When every player is ready at least one person counts to three, and on the count of three each player places their activated STRATEGY Card facedown onto the section of the designated playing area containing the POTUS Card that their activated STRATEGY Card is intended to affect (see {6D-8a} & {6E-8a}). The option would exist where more than one STRATEGY Card could be played on a single POTUS Card whereby the STRATEGY Cards' Order of Execution would be necessary. Once every player has put a STRATEGY Card onto the designated playing area all players turn their activated STRATEGY Cards faceup. At this point if one of the players says “MOUSETRAP” everyone eligible takes hold of their On-Deck MOUSETRAP Card and once again at least one person counts to three. On the count of two any player that has an On-Deck MOUSETRAP Card that affects a single card (red & blue backgrounds) can choose to activate their On-Deck MOUSETRAP Card by placing it facedown onto the section of the playing surface containing the POTUS Card ({6D-8} & {6E-8}) or STRATEGY Card ({6D-8a} & {6E-8a}) the MOUSETRAP Card is intended to affect. Any player that has an On-Deck MOUSETRAP Card whose affects aren't specific to a single card (yellow, green, purple and orange backgrounds) can choose to activate their On-Deck MOUSETRAP Card by turning it faceup on the count of three when all activated MOUSETRAP Cards will be turned faceup. The MOUSETRAP Cards' Order of Execution would be necessary (see {3A-6} where the “X” represents a number indicating each MOUSETRAP Card's place in the Order of Execution) as more than one MOUSETRAP Card could affect a POTUS Card or Cards, STRATEGY Card or Cards and/or all cards in play. After the effects of the MOUSETRAP Cards have been determined and actualized, and their effects on the STRATEGY Cards have been assessed, after the resulting effects of the combination of MOUSETRAP Cards and STRATEGY Cards on the point totals of the POTUS Cards have been assessed, of the players who have positive points that match the category identified by The Dice, the player with the highest point total wins the round. If no one calls for the MOUSETRAP Cards to be played, then, after the effects of the STRATEGY Cards on the point totals of the POTUS Cards have been assessed, of the players who have positive points that match the category identified by The Dice, the player with the highest point total wins the round. In case of a tie, the primary tie-breaker could be the player that has the most points that match the category identified by The Dice. If no one has points that match the category identified by The Dice, the player with the highest total points could win the round. The ultimate tie-breaker could be the POTUS Card that comes first in chronological order. In a typical game the winner of the round collects all of the cards played and puts the POTUS Cards and STRATEGY Cards into their respective reserve areas (see {6D-7}, {6D-7a}, {6E-7} and {6E-7a}) and puts the MOUSETRAP Cards at the bottom of their MOUSETRAP Card deck in their reserve area at which point their opponent(s) will have the option to shuffle the MOUSETRAP Card deck. Then all players take a new card from the top of their On-Deck POTUS Card deck, from the top of their On-Deck STRATEGY Card deck and, if the player activated their On-Deck MOUSETRAP Card, then they also take a card from the top of their MOUSETRAP Card deck to add the cards to their “hand”. After a player runs out of POTUS Cards and STRATEGY Cards in their On-Deck area they take the POTUS Card and STRATEGY Card decks of cards from their reserve area and shuffle them separately, after which their opponents can have the option to cut the decks, then the decks are placed into their respective sections in the On-Deck area (see {6D-6}, {6D-6a}, {6E-6} and {6E-6a}) and play continues. This continues until only one player has collected all of the POTUS Cards and STRATEGY Cards and wins the game. Alternatively, the game could end when one of the players has run out of POTUS Cards and STRATEGY Cards or run out of POTUS Cards and STRATEGY Cards with no chance to get more via their On-Deck MOUSETRAP Card, then the goal of the game could be to collect more POTUS Cards & STRATEGY Cards than your opponents. In alternate versions of the current embodiment the winner of each round could be the player with the lowest total points, the player with the highest number of points that match the category identified by The Dice, the player with the lowest number of points that match the category identified by The Dice, etc. In another version of the Deluxe Game, the big loser of each round would be the one to collect all of the cards played; then, the goal of the game could be to rid yourself of the most or all of your POTUS Cards & STRATEGY Cards. The goal of the game in other versions could be to either have the highest running point total, the lowest running point total, to collect the most or all of the assigned tokens, to rid yourself of the most or all of the assigned tokens, etc. In alternate versions of the current embodiment the rolling of The Dice could solely and/or also determine which STRATEGY and/or MOUSETRAP Cards could be played for that round.

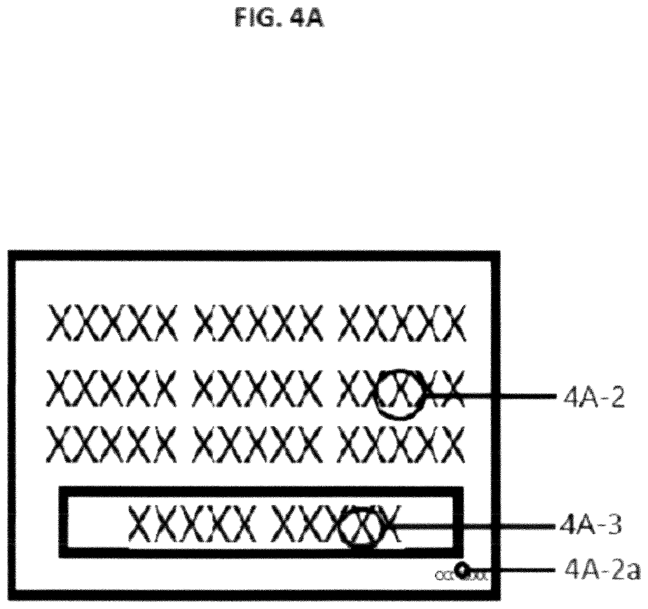

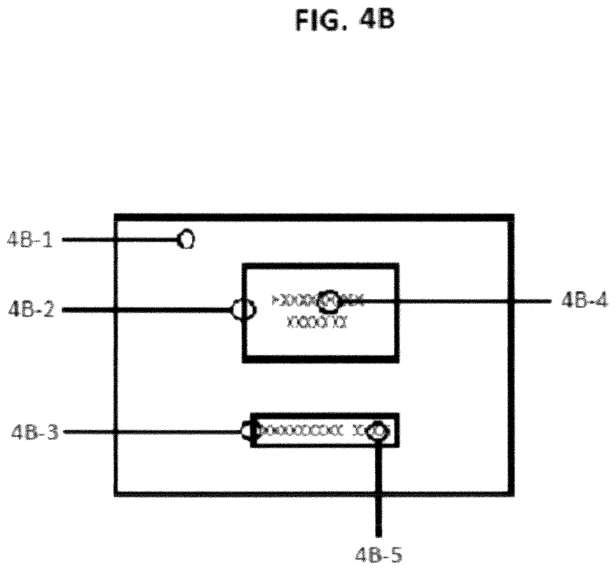

In another embodiment of the invention which could be played on a pre-printed gameboard (see 6F & 6G) and will hereafter be referred to as the “Advanced Game”, in addition to assigning each player POTUS Cards, STRATEGY Cards and MOUSETRAP Cards as in the Deluxe Game, there will be a collection of SNAFU Cards (see FIGS. 4 and 4A) made available to all players, such as having a deck of SNAFU Cards in a designated SNAFU area (see {6F-9} & {6G-9}), that could be brought into play via a MOUSETRAP Card which can have a unique identifier from the other MOUSETRAP Cards such as all other MOUSETRAP Cards having assorted solid-colored backgrounds while the one that brings a SNAFU Card into play could have a multi-colored background. There could be other methods to bring a SNAFU Card into play such as a second random selector, an assigned token to play, a competitive process, a convergence of game events, etc. In a typical game where the SNAFU Cards are brought into play via a MOUSETRAP Card, by random selection or by each player taking turns selecting from the respective decks, each player is assigned an equal number of POTUS Cards and an identical number of STRATEGY Cards, as well as an equal number of MOUSETRAP Cards with any residual cards from the three decks set aside not to be used nor identified. After all cards have been assigned, each player separately shuffles their POTUS Card deck, their STRATEGY Card deck and their MOUSETRAP Card deck after which the opponents may cut each other's decks. Then each player assembles their initial “hand” by taking an identical, predetermined number of cards from the tops of their POTUS Card and STRATEGY Card decks, as well as a predetermined number of their MOUSETRAP Cards from that deck. Each round would begin with every player that still possesses at least one MOUSETRAP Card having a MOUSETRAP Card facedown in their designated, On-Deck sections (see {6F-6b} & {6G-6b}). After one of the players takes their turn rolling The Dice, which will reveal which POTUS category would put a player in primary contention to win that round, each player places a POTUS Card from their “hand” onto the designated playing area facedown (see {6F-8} & {6G-8}). After all players have placed a POTUS Card onto the designated playing area they all turn their POTUS Cards on the designated playing area faceup, and then each player activates a STRATEGY Card by pulling the STRATEGY Card from their “hand” while keeping its identity hidden. When every player is ready at least one person counts to three, and on the count of three each player places their activated STRATEGY Card facedown onto the section of the designated playing area containing the POTUS Card that their activated STRATEGY Card is intended to affect (see {6F-8a} & {6G-8a}). The option would exist where more than one STRATEGY Card could be played on a single POTUS Card whereby the STRATEGY Cards' Order of Execution would be necessary. Once every player has put a STRATEGY Card onto the designated playing area all players turn their activated STRATEGY Cards faceup. At this point if one of the players says “MOUSETRAP” everyone eligible takes hold of their On-Deck MOUSETRAP Card and once again at least one person counts to three. On the count of two any player that has a MOUSETRAP Card that affects a single card can choose to activate their On-Deck MOUSETRAP Card by placing it facedown onto the section of the playing surface containing the POTUS Card ({6F-8} & {6G-8}) or STRATEGY Card ({6F-8a} & {6G-8a}) the MOUSETRAP Card is intended to affect. Any player that has an On-Deck MOUSETRAP Card that has affects that aren't specific to a single card can choose to activate their On-Deck MOUSETRAP Card by turning it faceup on the count of three when all activated MOUSETRAP Cards are turned faceup. The MOUSETRAP Cards' Order of Execution would be necessary as more than one MOUSETRAP Card could affect a POTUS Card or Cards, STRATEGY Card or Cards and/or all cards in play. If a player's MOUSETRAP Card instructs them to flip over a SNAFU Card, then after the SNAFU Card's effects on the MOUSETRAP Cards have been determined, assessed and actualized, and the combination of the effects of the SNAFU and MOUSETRAP Cards on the STRATEGY Cards have been determined, assessed and actualized, after the combination of the effects of the SNAFU, MOUSETRAP and STRATEGY Cards on the point totals of the POTUS Cards have been determined, assessed and actualized, of the players that have positive points that match the category identified by The Dice, the one with the highest point total wins the round. If no one presents the MOUSETRAP Card that instructs them to flip over a SNAFU Card, then after the effects of the MOUSETRAP Cards have been determined and actualized, and their effects on the STRATEGY Cards have been assessed, after the resulting effects of the STRATEGY Cards on the point totals of the POTUS Cards have been assessed, of the players who have positive points that match the category identified by The Dice, the player with the highest point total wins the round. If no one calls for the MOUSETRAP Cards to be played then after the effects of the STRATEGY Cards on the point totals of the POTUS Cards have been assessed, of the players who have positive points that match the category identified by The Dice, the player with the highest point total wins the round. In case of a tic, the primary tie-breaker could be the player that has the most points that match the category identified by The Dice. If no one has points that match the category identified by The Dice, the card with the highest total points could win the round, and the ultimate tie-breaker could be the POTUS Card that comes first in chronological order. In a typical game the winner of the round collects all of the cards played and puts the POTUS Cards and STRATEGY Cards into their respective reserve areas (see {6F-7}, {6F-7a}, {6G-7} and {6G-7a}) and puts the MOUSETRAP Cards at the bottom of their MOUSETRAP Card deck in its reserve area (see {6F-7b} and {6G-7b}) at which point their opponent(s) will have the option to shuffle the MOUSETRAP Card deck. Then all players take a new card from the top of their On-Deck POTUS Card deck, from the top of their On-Deck STRATEGY Card deck and, if the player activated their On-Deck MOUSETRAP Card, then they also take a card from the top of their MOUSETRAP Card deck to add the cards to their “hand”. After a player runs out of POTUS Cards and STRATEGY Cards in their On-Deck area they take the POTUS Card and STRATEGY Card decks of cards from their reserve area and shuffle them separately, after which their opponents can have the option to cut the decks, then the decks are placed into their respective sections in the On-Deck area (see {6F-6}, {6F-6a}, {6G-6} and {6G-6a}) and play continues. This continues until only one player has collected all of the POTUS Cards and STRATEGY Cards and wins the game. Alternatively, the game could end when one of the players has run out of POTUS Cards and STRATEGY Cards or run out of POTUS Cards and STRATEGY Cards with no chance to get more via their On-Deck MOUSETRAP Card, then the goal of the game could be to collect more POTUS Cards & STRATEGY Cards than your opponents. In alternate versions of the current embodiment the winner of each round could be the player with the lowest total points, the player with the highest number of points that match the category identified by The Dice, the player with the lowest number of points that match the category identified by The Dice, etc. In another version of the Advanced Game, the big loser of each round would be the one to collect all of the cards played; then, the goal of the game could be to rid yourself of the most or all of your POTUS Cards & STRATEGY Cards. The goal of the game in other versions could be to either have the highest running point total, the lowest running point total, to collect the most or all of the assigned tokens, to rid yourself of the most or all of the assigned tokens, etc. In alternate versions of the current embodiment the rolling of The Dice could solely and/or also determine which STRATEGY and/or MOUSETRAP Cards could be played for that round.

POTUS Cards can also be used in an alternate embodiment of the Beginners Game that includes SNAFU Cards.

POTUS Cards and STRATEGY Cards can also be used in an alternate embodiment of the Standard Game that includes SNAFU Cards.

POTUS Cards and MOUSETRAP Cards can also be used in an alternate embodiment of the Deluxe Game that doesn't include STRATEGY Cards.

POTUS Cards and MOUSETRAP Cards can also be used in an alternate embodiment of the Advanced Game that doesn't include STRATEGY Cards but does include SNAFU Cards.

The game components consist of cards having a playing face on one side, a specialized die and an optional playing board.

Referring initially to FIGS. 1 & 1A, 2 & 2A, 3 & 3A, and 4 & 4A, depicted therein are four types of cards that would be included in the various versions of the game. Other types of cards may also be included to further enhance the game. Each of the cards are preferably constructed of sturdy card stock ({1-1}, {2-1}, {3-1} & {4-1}).

POTUS Cards (FIGS. 1 & 1A) have playing faces ({1-2}) on which are set forth illustrations ({1-8 & 1-14) and associated indicia about the person(s) or persona(s) depicted in the illustrations. Some data would simply be informational ({1A-9}, {1A-15} & {1A-18}); some data would assign and describe point values per card ({1A-4}, {1A-6}, {1A-7}, {1A-11}, {1A-16} & {1A-17}) as well as other informational data that may have an effect on gameplay, such as using the chronological/sequential placement of the figure ({1A-19}) as a tie-breaker, and some data may simply be included for entertainment purposes, such as fictional nicknames ({1A-3} & {1A-12}), and fictional attributes such as super-human abilities ({1A-13}). POTUS Cards would have a top border {1-3} which would have a box on each corner {1-4}. The top border would have the text of the POTUS' alias {1A-3} and the top border corner boxes would contain the point total of the POTUS Card before being affected by any STRATEGY Card, MOUSETRAP Card or SNAFU Card {1A-4}. The playing faces of each POTUS Card will have a background {1-5}. POTUS Cards would have a side borders {1-9} which would each have big boxes {1A-6} and small boxes {1A-7}. The side borders' big boxes would contain the indicia of the POTUS' POTUS categories {1A-6} and the side borders' small boxes would contain the point totals of the POTUS' POTUS categories {1A-7}.

STRATEGY Cards (FIGS. 2 & 2A) have playing faces (2-2) on which are set forth indicia that would describe which POTUS Cards in play would be affected by the STRATEGY Card (2A-4 & 2A-5), the card's effect on POTUS Cards in play (2A-2, 2A-8 & 2A-9), as well as the order that the STRATEGY Card would take effect if two or more STRATEGY Cards are played on the same POTUS Card (2A-6).

MOUSETRAP Cards (FIGS. 3 & 3A) have playing faces (3-2) on which are set forth indicia that would describe which Card Type would be affected (3A-4 & 3A-5): POTUS Cards, STRATEGY Cards, MOUSETRAP Cards, any combination of, or all of the three. The indicia would also describe the MOUSETRAP Card's effect on the other cards in play (3A-2, 3A-8 & 3A-9), as well as the order in which the MOUSETRAP Cards would take effect if two or more MOUSETRAP Cards are played at the same time (3A-6).

SNAFU Cards (FIGS. 4 & 4A) have playing faces (4-2) on which are set forth indicia that would describe the effect the card would have on all POTUS Cards and/or STRATEGY Cards and/or MOUSETRAP Cards in play or to be played (4A-2 & 4A-3).

FIG. 1 is the illustration of the layout of a typical POTUS Card. Item {1-1} is the POTUS Card itself. Item {1-2} is the playing face of the POTUS Card on which all subsequent items on Item {1-1} are displayed. Item {1-3} is the top border of the POTUS Card. Item {1-4} is one of the corner boxes of the top border of the POTUS Card. Item {1-5} on the playing face is the background of the POTUS Card. Item {1-6} is one of the big boxes on the side borders (see Item 9) of the POTUS Card. Item {1-7} is one of the small boxes on the side borders of the POTUS Card. Item {1-8} on the playing face of the POTUS Card is a fictional depiction of the POTUS character. Item {1-9} is one of the side borders of the POTUS Card. Item {1-10} on the playing face of the POTUS Card is the grid. Item {1-11} is one of the boxes in the left column of the POTUS Card's grid. Item {1-12} is the small box on the playing face of the POTUS Card. Item {1-13} is the wide box on the playing face of the POTUS Card. Item {1-14} is a portrait of the POTUS personality on the playing face of the POTUS Card. Item {1-15} is the big box on the playing face of the POTUS Card. Item {1-16} is one of the boxes in the middle column of the POTUS Card's grid. Item {1-17} is one of the boxes in the right column of the POTUS Card's grid. Item {1-18} is the box on the bottom of the POTUS Card's grid. Item {1-19} is the bottom border of the POTUS Card. Item {1-20} is the outside edge of the POTUS Card. Item {1-21} is the inside border line of the POTUS Card.

FIG. 1A demonstrates the text and indicia on a typical POTUS Card. Item {1A-3} is the text in the top border describing the fictional depiction or alias of the POTUS character. Item {1A-4} represents the text in the corner boxes of the top border showing the POTUS Card's total points prior to any adjustments caused by STRATEGY, MOUSETRAP and/or SNAFU Cards. Item {1A-6} represents the symbols of the POTUS Card's categories in the big boxes on the side borders. Item {1A-7} represents the text in the small boxes on the side borders showing the POTUS Card's category's points for the category depicted in the larger box immediately above the small box prior to any adjustments caused by STRATEGY, MOUSETRAP and/or SNAFU Cards. Item {1A-9} represents the text in the side borders showing the POTUS character's actual name's first and middle initials & surname. Item {1A-11} represents the text in the boxes of the grid's Left column showing the POTUS Card's Category Symbols. Item {1A-12} is the text in the Small box of the POTUS Card's playing face describing the fictional depiction or Alias of the POTUS character. Item {1A-13} is the text in the wide box of the POTUS Card's playing face describing the fictional Attributes of the POTUS character. Item {1A-15} is the text in the big box of the POTUS Card's playing face showing the POTUS character's Actual Name along with a general biographical summary. Item {1A-16} represents the text in the boxes of the grid's middle column showing the explanation of the POTUS Card's point value for each of the POTUS Card's categories. Item {1A-17} represents the text in the boxes of the grid's right column showing the POTUS Card's category's points prior to any adjustments caused by STRATEGY, MOUSETRAP and/or SNAFU Cards. Item {1A-18} represents the text in the box at the bottom of the grid showing informational trivia about the POTUS character. Item {1A-19} is the text in the bottom border of the POTUS Card showing the POTUS character's chronological position amongst all of the POTUS characters. Item {1A-19a} is the text in the bottom border of the POTUS Card showing the name of the illustrator/designer.

FIG. 1B is the illustration of the layout of the back surface opposite the playing face of all POTUS Cards, hereafter to be referred to as the “first main back-side face”. Item {1B-2} is the box on the first main back-side face. Item {1B-3} is the text in the box on the first main back-side face of the cards which displays the logo and/or brand name of the game.

FIG. 1C is the illustration of the layout of the back surface opposite the playing face of all STRATEGY Cards and MOUSETRAP Cards, hereafter to be referred to as the “second main back-side face”. Item {1C-2} is the big box on the second main back-side face. Item {1C-3} is the text in the big box on the second main back-side face of the cards which displays the logo and/or brand name of the game. Item {1C-4} is the small box on the second main back-side face. Item {1C-5} is the text in the small box on the second main back-side face of the cards which displays the type of card it is; e.g., “STRATEGY Card”, “MOUSETRAP Card”, etc.

FIG. 2 is the illustration of the layout of a typical STRATEGY Card. Item {2-1} is the STRATEGY Card itself. Item {2-2} is the playing face of the STRATEGY Card on which all subsequent items on Item {2-1} are displayed. Item {2-3} is the top border of the STRATEGY Card. Item {2-4} is one of the corner boxes of the top border of the STRATEGY Card. Item {2-5} is the middle box of the top border of the STRATEGY Card. Item {2-6} on the playing face is the background of the STRATEGY Card. Item {2-7} is one of the side borders of the STRATEGY Card. Item {2-8} is one of the long boxes on the side borders of the STRATEGY Card. Item {2-9} is the extra-wide box on the playing face of the STRATEGY Card. Item {2-10} is the bottom border of the STRATEGY Card. Item {2-11} is the outside edge of the STRATEGY Card. Item {2-12} is the inside border line of the STRATEGY Card.

FIG. 2A demonstrates the text and indicia on a typical STRATEGY Card. Item {2A-2} is the text on the playing face of the STRATEGY Card which displays the instruction on the function of the particular STRATEGY Card. Item {2A-4} represents the text in the corner boxes of the top border of the STRATEGY Card showing the category symbol which represents the category and/or categories on the POTUS Card that the particular STRATEGY Card would affect. Item {2A-5} represents the text in the middle box of the top border of the STRATEGY Card showing the category on the POTUS Card that the particular STRATEGY Card would affect. Item {2A-6} is the numeric text on the playing face of the STRATEGY Card which displays the particular STRATEGY Card's place in the Order of Execution of all STRATEGY Cards played during each round. Item {2A-8} is the text in the long boxes of the side borders of the STRATEGY Card which displays the function of the particular STRATEGY Card. Item {2A-9} is the text in the extra-wide box on the playing face of the STRATEGY Card which displays additional instruction on the function of the particular STRATEGY Card. Item {2A-10} is the text in the bottom border of the STRATEGY Card showing the name of the illustrator/designer.

FIG. 3 is the illustration of the layout of a typical MOUSETRAP Card. Item {3-1} is the MOUSETRAP Card itself. Item {3-2} is the playing face of the MOUSETRAP Card on which all subsequent items on Item {3-1} are displayed. Item {3-3} is the top border of the MOUSETRAP Card. Item {3-4} is one of the corner boxes of the top border of the MOUSETRAP Card. Item {3-5} is the middle box of the top border of the MOUSETRAP Card. Item {3-6} on the playing face is the background of the MOUSETRAP Card. Item {3-7} is one of the side borders of the MOUSETRAP Card. Item {3-8} is the bottom border of the MOUSETRAP Card. Item {3-9} is one of the long boxes on the side borders of the MOUSETRAP Card. Item {3-10} is the extra-wide box on the playing face of the MOUSETRAP Card. Item {3-11} is the outside edge of the MOUSETRAP Card. Item {3-12} is the inside border line of the MOUSETRAP Card.

FIG. 3A demonstrates the text and indicia on a typical MOUSETRAP Card. Item {3A-2} is the text on the playing face of the MOUSETRAP Card which displays the instruction on the function of the particular MOUSETRAP Card. Item {3A-4} represents the text in the corner boxes of the top border of the MOUSETRAP Card showing the indicia, such as an initial or a symbol, which represents the type of card and/or cards that the particular MOUSETRAP Card would affect. Item {3A-5} represents the text in the middle box of the top border of the MOUSETRAP Card showing the type of card and/or cards that the particular MOUSETRAP Card would affect. Item {3A-6} is the numeric text on the playing face of the MOUSETRAP Card which displays the particular MOUSETRAP Card's place in the Order of Execution of all MOUSETRAP Cards played during each round. Item {3A-8} is the text in the bottom border of the MOUSETRAP Card showing the name of the illustrator/designer. Item {3A-9} is the text in the long boxes of the side borders of the MOUSETRAP Card which displays the function of the particular MOUSETRAP Card. Item {3A-10} is the text in the extra-wide box on the playing face of the MOUSETRAP Card which displays additional instruction on the function of the particular MOUSETRAP Card.

FIG. 4 is the illustration of the layout of a typical SNAFU Card. Item {4-1} is the SNAFU Card itself. Item {4-2} is the playing face of the SNAFU Card. Item {4-3} is an optional extra-wide box on the playing face of the SNAFU Card.

FIG. 4A demonstrates the text on a typical SNAFU Card. Item {4A-2} is the text on the playing face of the SNAFU Card which displays the instruction on the function of the particular SNAFU Card. Item {4A-2a} is the text in the bottom border of the SNAFU Card showing the name of the illustrator/designer. Item {4A-3} is the text in the optional extra-wide box on the playing face of the SNAFU Card which displays additional instruction on the function of the particular SNAFU Card.

FIG. 4B is the illustration of the layout of the back surface opposite the playing face of all SNAFU Cards hereafter to be referred to as the “SNAFU's back-side face”. Item {4B-2} is the big box on the SNAFU'S back-side face. Item {4B-3} is the small box on the SNAFU's back-side face. Item {4B-4} is the text in the big box on the SNAFU's back-side face of the cards which displays the logo and/or brand name of the game. Item {4B-5} is the text in the small box on the SNAFU'S back-side face of the cards which displays the type of card it is; e.g., “SNAFU Card”.

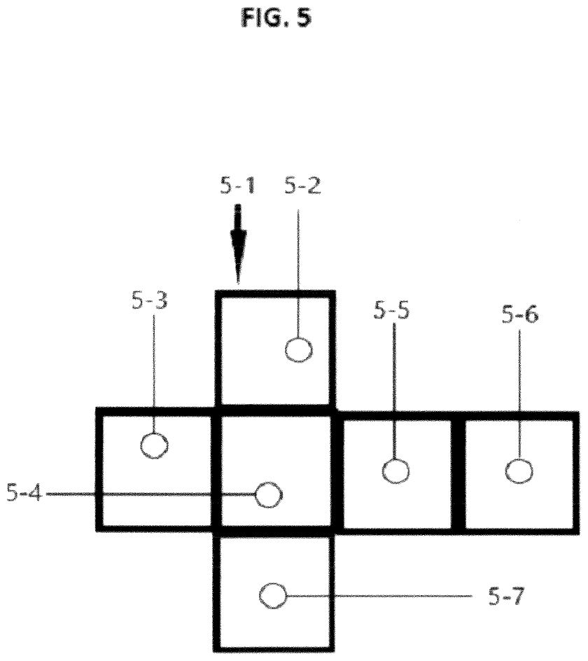

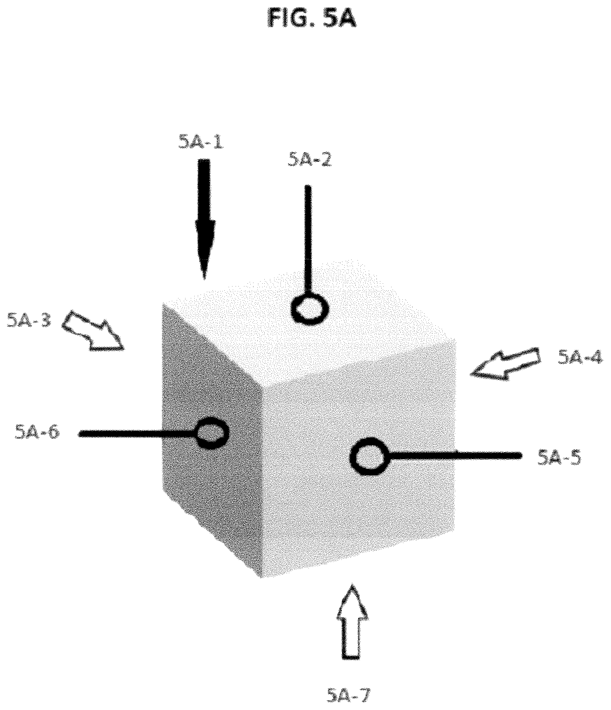

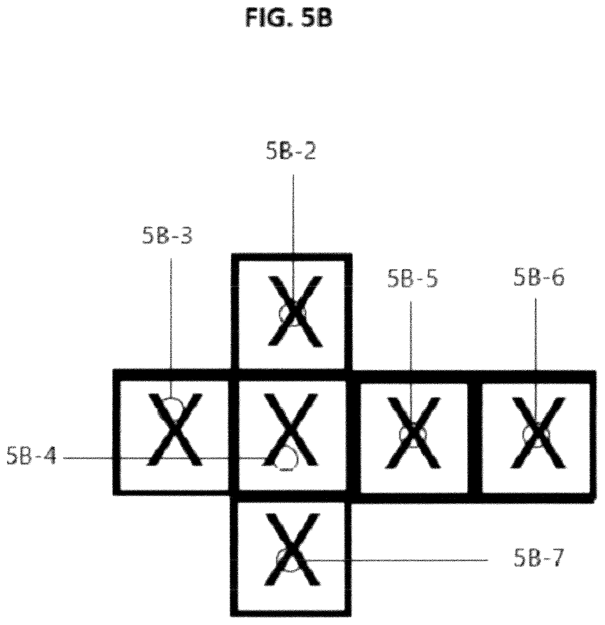

FIG. 5 is a two-dimensional illustration of the layout of The Dice. Item {5-1} is The Dice itself which would be a cube made from a substance such as wood or plastic. Items {5-2}, {5-3, {5-4}, {5-5}, {5-6} & {5-7} are the six faces of the cube.

FIG. 5A is a three-dimensional illustration of the layout of The Dice. Item {5A-1} is The Dice itself which would be a cube made from a substance such as wood or plastic. Items {5A-2}, {5A-3, {5A-4}, {5A-5}, {5A-6} & {5A-7} are the six faces of the cube.

FIG. 5B demonstrates the indicia on The Dice. Items {5B-2}, {5B-3, {5B-4}, {5B-5}, {5B-6} & {5B-7} are the indicia on each face of The Dice displaying symbols related to the POTUS Card's categories.

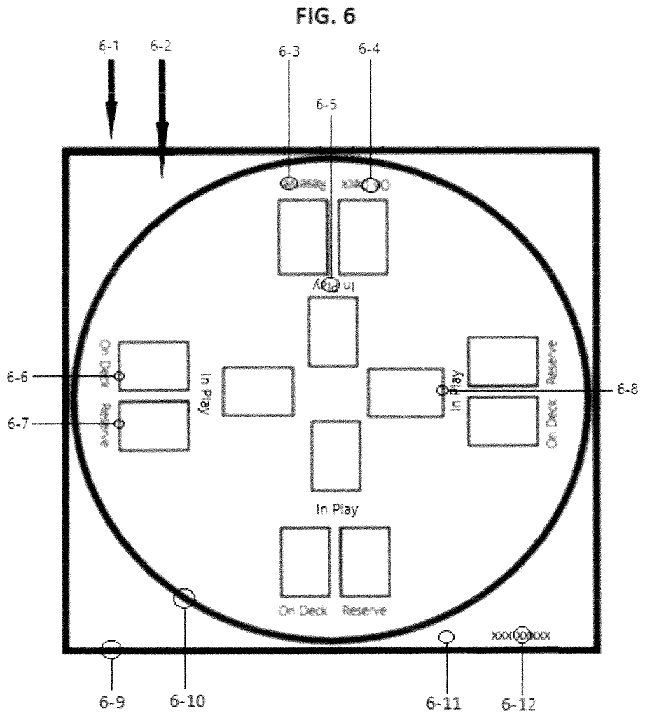

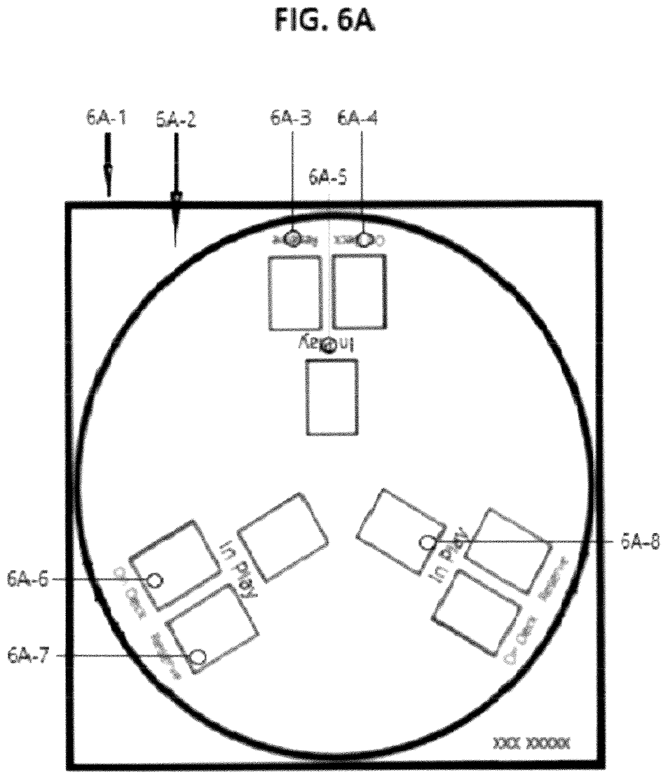

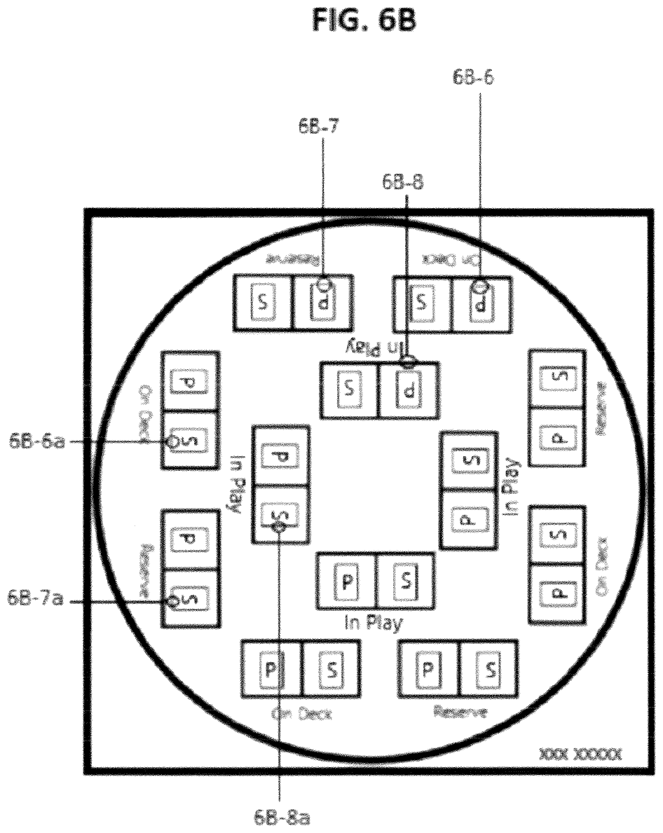

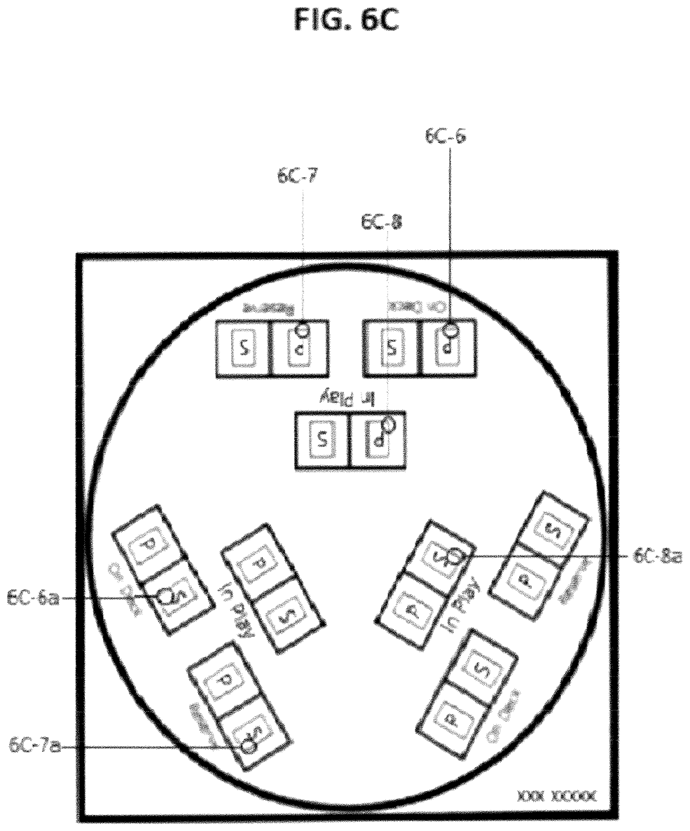

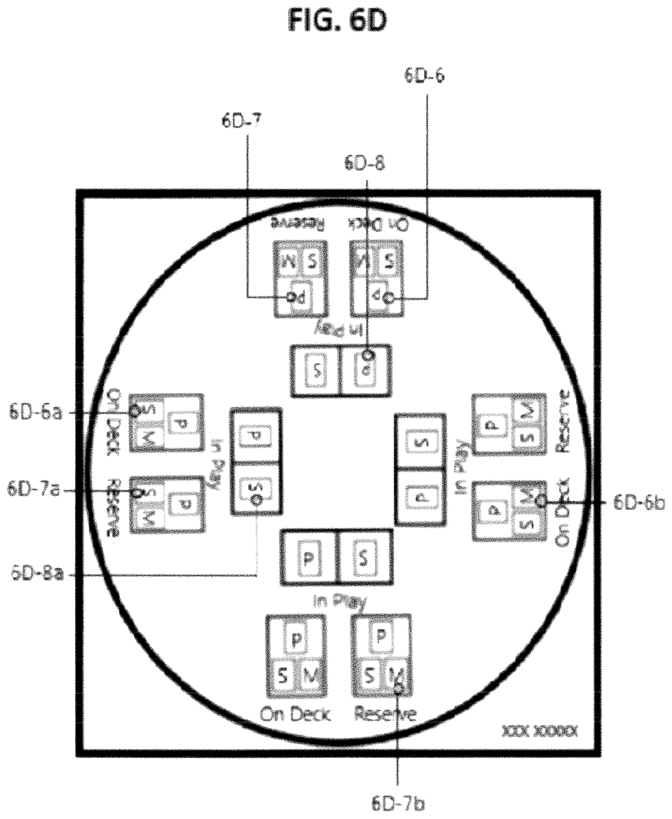

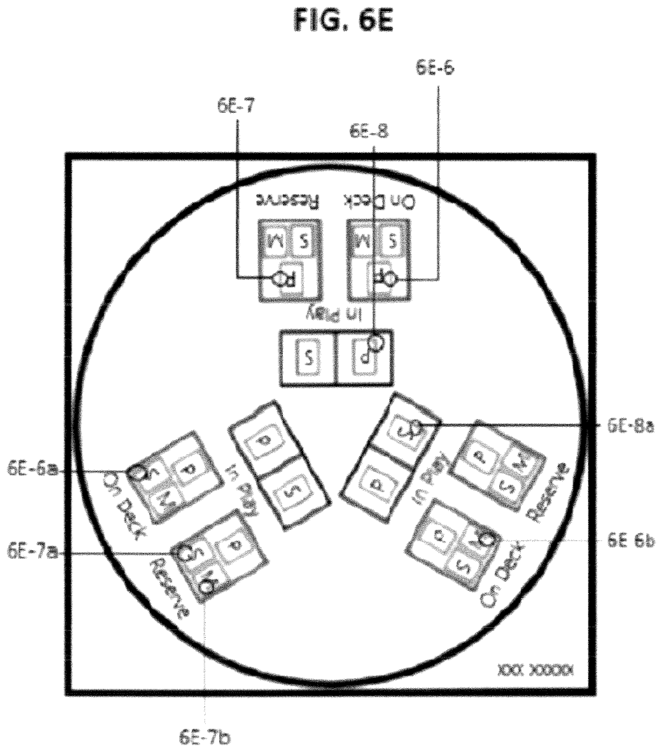

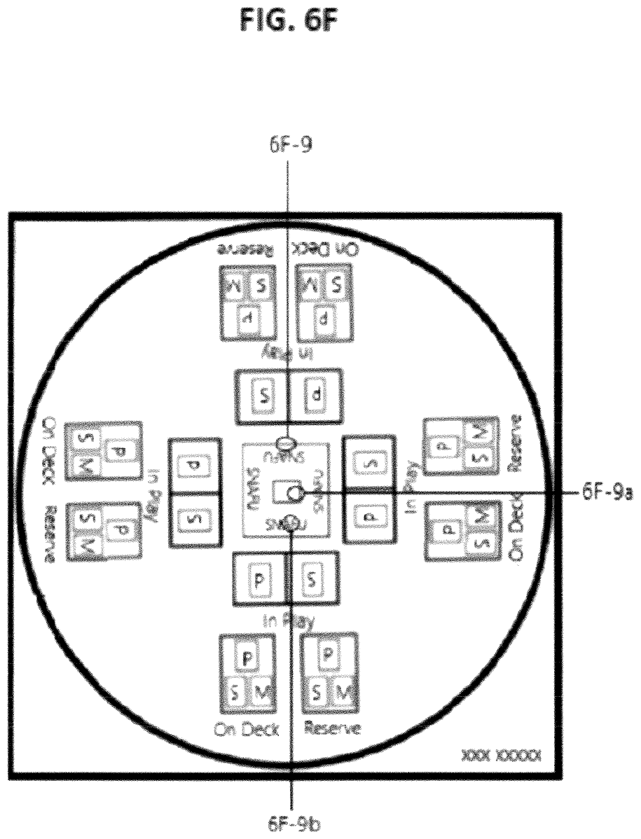

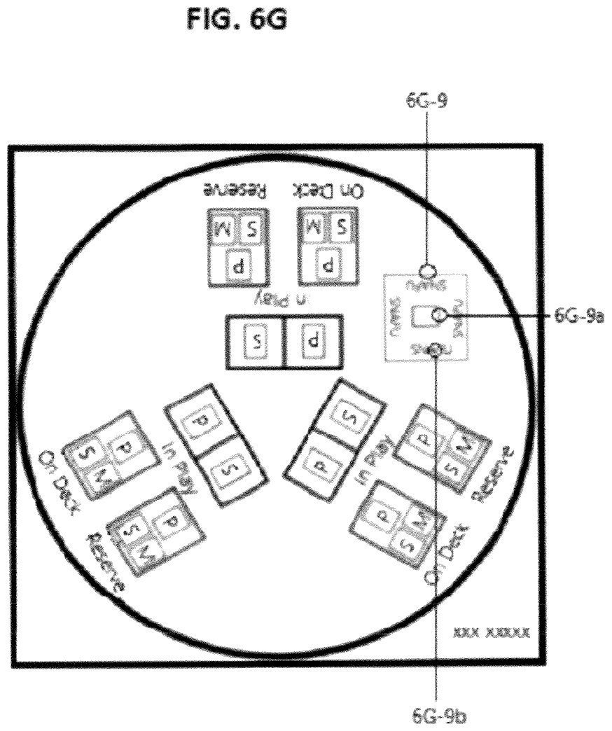

FIG. 6 is the illustration of the layout of the playing surface for two or four opponents for the Beginners game and FIG. 6A is the illustration of the layout of the playing surface for three opponents for the Beginners game. Items {6-1} & {6A-1} are the playing boards which would be constructed of plastic sheeting, plywood, corrugated fiberboard, coated paper or some other similar sturdy material on which the playing surfaces would be printed or affixed and could be printed/affixed on either side of the same board. Items {6-2} & {6A-2} represent the basic playing surfaces on which all subsequent described items will be displayed. Items {6-3} & {6A-3} are each text displaying the word “Reserve”. Items {6-4} & {6A-4} are each text displaying the words “On Deck”. Items {6-5} & {6A-5} are each text displaying the words “In Play”. Items {6-6} & {6A-6} are boxes representing the respective “On Deck” sections. Items {6-7} & {6A-7} are boxes representing the respective “Reserve” sections. Items {6-8} & {6A-8} are boxes representing the respective “In Play” sections. Item {6-9} is the outside edge of the playing surface. Item {6-10} is the inside border line of the playing surface. Item {6-11} is the outside border of the playing surface. Item {6-12} is text in the outside border displaying the name of the illustrator/designer.

FIG. 6B is the illustration of the layout of the playing surface for two or four opponents for the Standard game and FIG. 6C is the illustration of the layout of the playing surface for three opponents for the Standard game. Items {6B-6} & {6C-6} are boxes representing the respective “On Deck” sections for the POTUS Cards. Items {6B-7} & {6C-7} are boxes representing the respective “Reserve” sections for the POTUS Cards. Items {6B-8} & {6C-8} are boxes representing the respective “In Play” sections for the POTUS Cards. Items {6B-6a} & {6C-6a} are boxes representing the respective “On Deck” sections for the STRATEGY Cards. Items {6B-7a} & {6C-7a} are boxes representing the respective “Reserve” sections for the STRATEGY Cards. Items {6B-8a} & {6C-8a} are boxes representing the respective “In Play” sections for the STRATEGY Cards.

FIG. 6D is the illustration of the layout of the playing surface for two or four opponents for the Deluxe game and FIG. 6E is the illustration of the layout of the playing surface for three opponents for the Deluxe game. Items {6D-6} & {6E-6} are boxes representing the respective “On Deck” sections for the POTUS Cards. Items {6D-7} & {6E-6} are boxes representing the respective “Reserve” sections for the POTUS Cards. Items {6D-8} & {6E-6} are boxes representing the respective “In Play” sections for the POTUS Cards. Items {6D-6a} & {6E-6a} are boxes representing the respective “On Deck” sections for the STRATEGY Cards. Items {6D-7a} & {6E-6a} are boxes representing the respective “Reserve” sections for the STRATEGY Cards. Items {6D-8a} & {6E-6a} are boxes representing the respective “In Play” sections for the STRATEGY Cards. Items {6D-6b} & {6E-6b} are boxes representing the respective “On Deck” sections for the MOUSETRAP Cards. Items {6D-7b} & {6E-6b} are boxes representing the respective “Reserve” sections for the MOUSETRAP Cards.

FIG. 6F is the illustration of the layout of the playing surface for two or four opponents for the Advanced game and FIG. 6G is the illustration of the layout of the playing surface for three opponents for the Advanced game. Items {6F-9} & {6G-9} are boxes representing the respective “SNAFU” sections. Items {6F-9a} & {6G-9a} are boxes representing the respective areas for the SNAFU Cards. Items {6F-9b} & {6G-9b} are each text displaying the word “SNAFU”.

The invention claimed is:

1. A playing card game, comprising a plurality of actual or virtual POTUS Cards, a plurality of actual or virtual STRATEGY Cards, a plurality of actual or virtual MOUSETRAP Cards, a plurality of actual or virtual SNAFU Cards and an actual or virtual random selector depicting the game's categories, wherein:
each POTUS Card would contain entertaining, educational, and/or informational text in a grid divided into categories which would assign the entertaining, educational, and/or informational text point values;
each STRATEGY Card would have indicia that would describe which POTUS Cards in play would be affected by the STRATEGY Card, the card's effect on a POTUS Card or multiple POTUS Cards in play, as well as the order that the STRATEGY Card would take effect if two or more STRATEGY Cards are played on the same POTUS Card;
each MOUSETRAP Card would have indicia that would describe which Card Type would be affected, POTUS Cards, STRATEGY Cards, MOUSETRAP Cards, any combination of, or all three, and the indicia would also describe the MOUSETRAP Card's effect on the other cards in play, as well as the order in which the MOUSETRAP Cards would take effect if two or more MOUSETRAP Cards are played at the same time;
each SNAFU Card would have indicia that would describe the effect the card would have on all POTUS Cards and/or STRATEGY Cards and/or MOUSETRAP Cards in play or to be played;
the random selector would have indicia that would represent each, most or some of the categories indicated on the POTUS and/or STRATEGY Cards.

2. The playing card game of claim 1, wherein:
the random selector is used to choose the category that would make any playing card that has positive points in the category eligible to win the hand, and after every player presented a POTUS Card, of the players whose cards' have positive points in the chosen category, the player whose card has the highest total points would win the hand, in case of a tie then the player with the POTUS Card with the most points in the chosen category would win the hand, if there is still no resolution the player with the POTUS Card that is earliest in the line of succession would win the hand, if no POTUS Cards have positive points in the chosen category then the player with the highest total points would win the hand, if there is still no resolution the player with the POTUS Card that is earliest in the line of succession would win the hand.

3. The playing card game of claim 1, wherein:
the random selector is used to choose the category that would make any POTUS Card that has positive points in the category eligible to win the hand, and after every player has presented a POTUS Card each player may or must play a STRATEGY Card on their own or an opponent's POTUS Card, and after the effect of the STRATEGY Cards on each player's affected POTUS Card has been ascertained, of the players whose POTUS Cards have positive points in the chosen category, the player whose POTUS Card has the highest total points would win the hand, in case of a tie then the player with the POTUS Card with the most points in the chosen category would win the hand, if there is still no resolution the player with the POTUS Card that is earliest in the line of succession would win the hand, if no POTUS Cards have positive points in the chosen category then the player with the highest total points would win the hand, if there is still no resolution the player with the POTUS Card that is earliest in the line of succession would win the hand.

4. The playing card game of claim 1, wherein:
the random selector is used to choose the category that would make any POTUS Card that has positive points in the category eligible to win the hand, and after every player has presented a POTUS Card each player may or must play a STRATEGY Card on their own or an opponent's POTUS Card, and after the effect of the STRATEGY Cards on each player's affected POTUS Card has been ascertained the players might or must initiate the MOUSETRAP Card sequence where the players either may or must play a MOUSETRAP Card, and after the effects of the MOUSETRAP Cards on each player's affected POTUS Card, STRATEGY Card and/or MOUSETRAP Card has been ascertained, of the players whose POTUS Cards have positive points in the chosen category, the player whose POTUS Card has the highest total points would win the hand, in case of a tic then the player with the POTUS Card with the most points in the chosen category would win the hand, if there is still no resolution the player with the POTUS Card that is earliest in the line of succession would win the hand, if no POTUS Cards have positive points in the chosen category then the player with the highest total points would win the hand, if there is still no resolution the player with the POTUS Card that is earliest in the line of succession would win the hand.

5. The playing card game of claim 1, wherein:
the random selector is used to choose the category that would make any POTUS Card that has positive points in the category eligible to win the hand, and after every player has presented a POTUS Card each player may or must play a STRATEGY Card on their own or an opponent's POTUS Card, and after the effect of the STRATEGY Cards on each player's affected POTUS Card has been ascertained the players might or must initiate the MOUSETRAP Card sequence where the players either may or must play a MOUSETRAP Card, and after the effects of the MOUSETRAP Cards on each player's affected POTUS Card, STRATEGY Card and/or MOUSETRAP Card has been ascertained a player might initiate the SNAFU sequence, and after the effect of the SNAFU Card on each player's POTUS Card, STRATEGY Card and/or MOUSETRAP Card has been ascertained, of the players whose POTUS Cards have positive points in the chosen category, the player whose POTUS Card has the highest total points would win the hand, in case of a tie then the player with the POTUS Card with the most points in the chosen category would win the hand, if there is still no resolution the player with the POTUS Card that is earliest in the line of succession would win the hand, if no POTUS Cards have positive points in the chosen category then the player with the highest total points would win the hand, if there is still no resolution the player with the POTUS Card that is earliest in the line of succession would win the hand.

6. The playing card game of claim 1, wherein:
the random selector is used to choose the category that would make any POTUS Card that has positive points in the category eligible to win the hand, and after every player has presented a POTUS Card the players might or must initiate the MOUSETRAP Card sequence where the players either may or must play a MOUSETRAP Card, and after the effects of the MOUSETRAP Cards on each player's affected POTUS Card and/or MOUSETRAP Card has been ascertained, of the players whose POTUS Cards have positive points in the chosen category the player whose POTUS Card has the highest total points would win the hand, in case of a tie then the player with the POTUS Card with the most points in the chosen category would win the hand, if there is still no resolution the player with the POTUS Card that is earliest in the line of succession would win the hand, if no POTUS Cards have positive points in the chosen category then the player with the highest total points would win the hand, if there is still no resolution the player with the POTUS Card that is earliest in the line of succession would win the hand.

7. The playing card game of claim 1, wherein:
the random selector is used to choose the category that would make any POTUS Card that has positive points in the category eligible to win the hand, and after every player has presented a POTUS Card the players might or must initiate the MOUSETRAP Card sequence where the players either may or must play a MOUSETRAP Card, and after the effects of the MOUSETRAP Cards on each player's affected POTUS Card and/or MOUSETRAP Card has been ascertained a player might initiate the SNAFU sequence, and after the effect of the SNAFU Card on each player's POTUS Card and/or MOUSETRAP Card has been ascertained, of the players whose POTUS Cards have positive points in the chosen category, the player whose POTUS Card has the highest total points would win the hand, in case of a tie then the player with the POTUS Card with the most points in the chosen category would win the hand, if there is still no resolution the player with the POTUS Card that is earliest in the line of succession would win the hand, if no POTUS Cards have positive points in the chosen category then the player with the highest total points would win the hand, if there is still no resolution the player with the POTUS Card that is earliest in the line of succession would win the hand.

8. The playing card game of claim 1, wherein:
the random selector is used to choose the category that would make any POTUS Card that has positive points in the category eligible to win the hand, and after every player has presented a POTUS Card each player may or must play a STRATEGY Card on their own or an opponent's POTUS Card, and after the effect of the STRATEGY Cards on each player's affected POTUS Card has been ascertained the players might or must initiate the SNAFU sequence and after the effect of the SNAFU Card on each player's POTUS Card and/or STRATEGY Card has been ascertained, of the players whose POTUS Cards have positive points in the chosen category the player whose POTUS Card has the highest total points would win the hand, in case of a tie then the player with the POTUS Card with the most points in the chosen category would win the hand, if there is still no resolution the player with the POTUS Card that is earliest in the line of succession would win the hand, if no POTUS Cards have positive points in the chosen category then the player with the highest total points would win the hand, if there is still no resolution the player with the POTUS Card that is earliest in the line of succession would win the hand.

9. The playing card game of claim 1, wherein:
the random selector is used to choose the category that would make any POTUS Card that has positive points in the category eligible to win the hand, and after every player has presented a POTUS Card the players might or must initiate the SNAFU sequence and after the effect of the SNAFU Card on each player's POTUS Card has been ascertained, of the players whose POTUS Cards have positive points in the chosen category the player whose POTUS Card has the highest total points would win the hand, in case of a tie then the player with the POTUS Card with the most points in the chosen category would win the hand, if there is still no resolution the player with the POTUS Card that is earliest in the line of succession would win the hand, if no POTUS Cards have positive points in the chosen category then the player with the highest total points would win the hand, if there is still no resolution the player with the POTUS Card that is earliest in the line of succession would win the hand.
